(19) United States
(12) Patent Application Publication
(10) Pub. No.: US 2008/0185544 A1
(43) Pub. Date: Aug. 7, 2008

(54) STRUCTURE FOR AIR CONTROL VALVE OF OXYGEN CONCENTRATOR

(76) Inventor: Cheng-Kang Yeh, Hsinchu City (TW)

Correspondence Address: RABIN & Berdo, PC, 1101 14TH STREET, NW, SUITE 500, WASHINGTON, DC, 20005, US

(21) Appl. No.: 11/695,130

(22) Filed: Apr. 2, 2007

(30) Foreign Application Priority Data
Feb. 1, 2007 (TW) 096201950

(51) Int. Cl. F16K 31/02

(52) U.S. Cl. 251/129.06

(57) ABSTRACT

A structure for air control valve of oxygen concentrator is provided, including a main body, a side cover, an electromagnetic valve, and a linkage unit. The side cover is engaged to the side of main body, the electromagnetic valve is located on side cover, and the linkage unit is located inside main body. The inside of main body is a space, divided by separating plates to form a plurality of communicating chambers, including intake chamber, main chamber, and expel chamber. The linkage unit includes a linkage rod with two sealing pads on the outer surface for opening or sealing the chambers during airflow switching. The main chamber is only connected to either intake chamber or expel chamber at a time. The inside of side cover includes a moveable piston to provide driving force for linkage unit movement. The electromagnetic valve is on side cover to control the piston timing.

### FIELD OF THE INVENTION

The present invention generally relates to an air control valve of oxygen concentrator, and more specifically to a structure for air control valve applicable to switching airflow in an oxygen concentrator.

### BACKGROUND OF THE INVENTION

A conventional oxygen concentrator usually uses molecular sieve to temporarily absorb the nitrogen from the air out of the compressor so that the out-flowing air has a higher oxygen concentration. After a period of time, the nitrogen concentration in the molecular sieve increases, and the molecular sieve must expel the nitrogen before being used in the above oxygen concentration process. Conventionally, the expulsion of nitrogen from the molecular sieve includes guiding the air entering the molecular sieve through the air outlet so that the highly concentrated nitrogen will be expelled by the switching of an air control valve. Therefore, a conventional oxygen concentrator usually has two molecular sieves so that when the air control valve switches the air from the compressor into one molecular sieve, the other molecular sieve is performing the nitrogen expulsion at the same time.

To provide an improved oxygen concentrator structure, the applicant filed an airflow module for oxygen concentrator (U.S. patent application Ser. No. 11/507,000 (2006)). To further stabilize the operation of the invention, the applicant further provides an improved air control valve structure to enable more smooth operation of the oxygen concentrator.

### SUMMARY OF THE INVENTION

The primary object of the present invention is to provide a structure for air control valve of oxygen concentrator for enabling smooth operation of airflow during the switching.

Another object of the present invention is to provide a structure for air control valve of oxygen concentrator by changing the sealing and airflow switching operation of the internal linkage unit. The valve switch of a conventional structure uses a piston moving back and forth for airflow switching. After a long time of use, the circumference of the piston is reduced due to the abrasion, and leakage will occur. The present invention uses two sealing pads on the outer surface of a linkage rod of the linkage unit. Using the vertical surface of the sealing pads to seal the inlet and outlet for airflow switching. The sealing effect is better and the life expectancy of the control valve is prolonged.

To achieve the above objects, the present invention provides a structure for air control valve of oxygen concentrator, including a main body, at least a side cover, at least an electromagnetic valve, and at least a linkage unit. The side cover is engaged to the side of the main body, and the electromagnetic valve is located on the side cover. The linkage unit is located inside the main body. The inside of the main body is a hollow space, divided by a plurality of separating plates to form a plurality of communicating chambers with the outside, including intake chamber, main chamber, and expel chamber. The linkage unit is placed inside the main body. The linkage unit includes a linkage rod. Two sealing pads are placed on the outer surface of the linkage rod. The sealing pads can be used for opening or sealing the above chambers during the airflow switching. The main chamber can only be connected to either intake chamber or expel chamber at a time. The inside of the side cover includes a moveable piston. The piston provides the driving force for the movement of the linkage unit. The electromagnetic valve is on the side cover to control the timing of the piston. Therefore, the control valve of the present invention can perform the airflow switching function.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a three-dimensional view of present invention;

FIG. 2 shows a three-dimensional view of the present invention from a different angle;

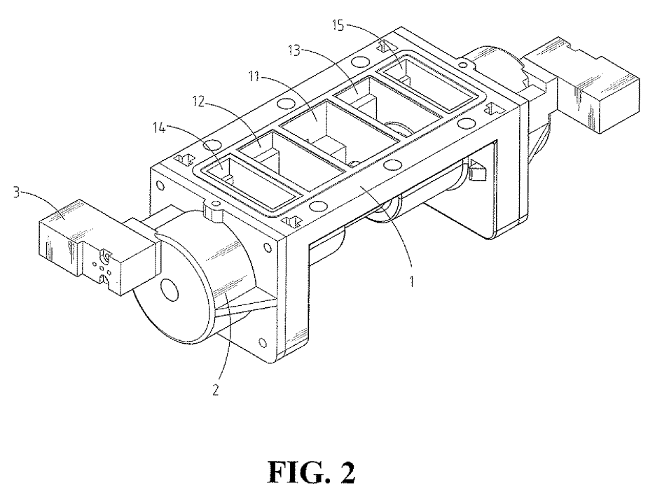

FIG. 3 shows a bottom view of the present invention;

FIG. 4 shows an exploded view of the present invention;

FIG. 5 shows cross-sectional view of the AA side of FIG. 1;

FIG. 6 shows a side view of the present invention;

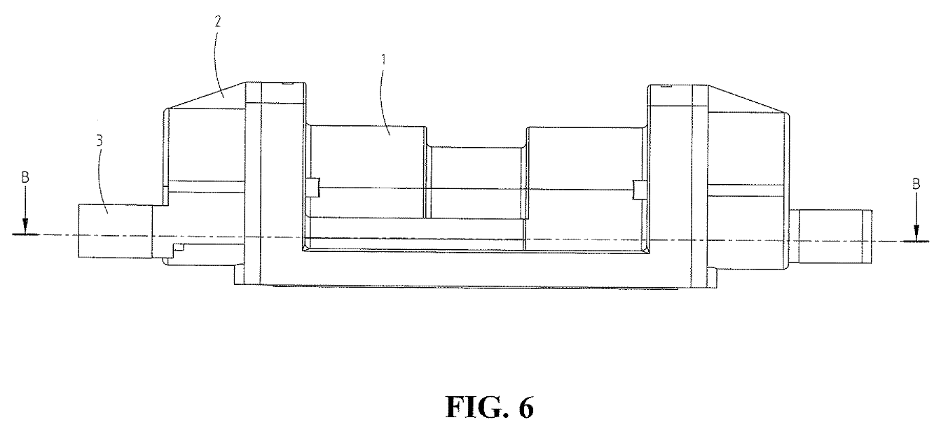

FIG. 7 shows cross-sectional view of the BB side of FIG. 6; and

FIG. 8 shows a partial cross-sectional view of the present invention during the expulsion process.

### DETAILED DESCRIPTION OF THE PREFERRED EMBODIMENTS

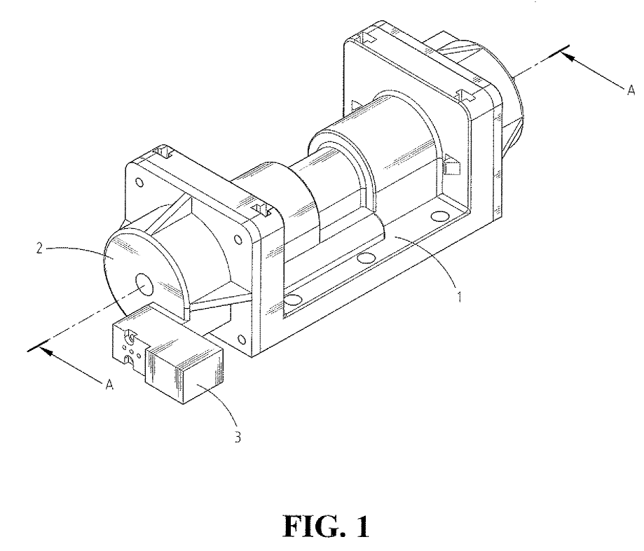

FIGS. 1 & 2 show schematic views of a structure of air control valve of oxygen concentrator of the present invention from different angles. A main body 1 of the air control valve includes an intake chamber 11, two main chambers 12, 13, and two expel chambers 14, 15. Main body 1 is divided at the center into two independent operation parts. In other words, the left side of intake chamber 1, main chamber 12, and expel chamber 14 operate as a group. The right side of intake chamber 11, main chamber 13 and expel chamber 15 operate as another group. Each group further includes a side cover 2, an electromagnetic valve 3 and a linkage unit (not shown in). The control valve operates in two different modes to accomplish the airflow switching. For explanation, the following uses the left side group for description. The right side group operates in the same manner. The first mode is the intake mode. The outside air enters main body 1 through intake chamber 11, and flows out from the outlet of main chamber 12. In this mode, expel chamber 14 is sealed. The second mode is the expel mode, or called nitrogen expel operation. The air from the oxygen concentrator enters main body 1 through main chamber 12, and flows out through expel chamber 14. The intake chamber 11 is closed during this mode. Although the two groups operate independently, they operate in different modes at any given time. In other words, when main chamber 12 of the left side of main body 1 intakes the air, the expel chamber 15 of the right side of main body 1 is expelling the air, and vice versa.

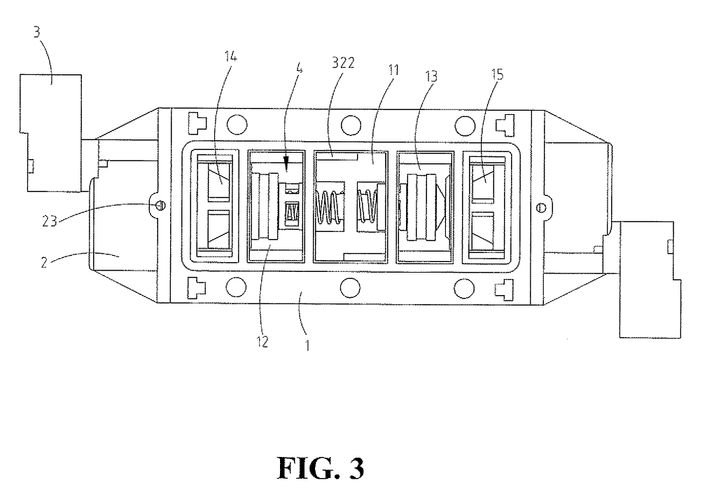

As the left side and the right side of the main body have the identical structure, and operate independently, the following description only describes the left structure of main body 1. FIG. 3 shows a schematic view of the air control valve of the present invention, including a main body 1, a side cover 2, an electromagnetic valve 3, and a linkage unit 4. Side cover 2 is engaged with the side of main body 1, electromagnetic valve 3 is located on side cover 2, and linkage unit 4 is located inside main body 1. The inside of main body 1 forms intake chamber 11, main chamber 12 and expel chamber 14 for acting as the inlet and outlet of airflow when working with other components of the oxygen concentrator. Linkage unit 4 can move to left and right for switching between the chambers. Side cover 2 uses the internal structure to provide the driving force for the movement of linkage unit 4. Electromagnetic valve 3 is responsible for controlling the timing of switching so that main chamber 12 of left side of main body 1 is connected to only either intake chamber 11 or expel chamber 14 at any given time.

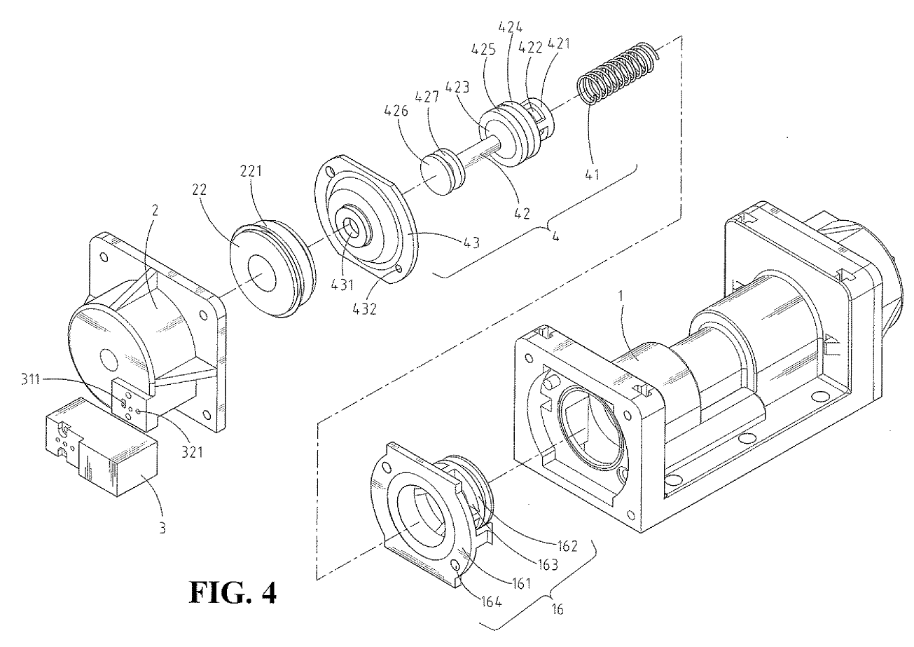

The following describes each component of the structure of the present invention. FIGS. 4 & 5 show the exploded view and the cross-sectional view of the AA side in FIG. 1, respectively. As shown in FIGS. 4 & 5, main body is a shell with a hollow internal space 10. Linkage unit 4 is placed inside space 10. Space 10 is further divided by a plurality of separating plates into an intake chamber 11, a main chamber 12 and an expel chamber 14, so that space 10 can communicate with the outside through each independent chamber. The chambers are acting as channels for the air intake and expulsion. A fixed seat 16 is located inside space 10 at the position close to intake chamber 14. The purpose of fixed seat 16 is to change the shape of space 10 as to match the operation of linkage unit 4. Fixed seat 16 is an engraved skeleton, including a hollow plate 161 and a protruding end 162. Plate 161 is placed at the conjunction of main body 1 and side cover 2. Protruding end 162 further includes an open groove 163.

Linkage unit 4 includes a spring 41, a linkage rod 42, and a moveable valve 43. Spring 41 is placed at the conjunction between space 10 and intake chamber 11. The right end of spring 41 is sheathed on protruding stub 101 of space 10. Linkage rod 42 is a long rod with a first end 421 on the right. First end 421 is hollow to accommodate spring 41. The outer circumference of first end 421 includes penetrating groove 422. The air, after entering intake chamber 11, flows to main chamber 12 through penetrating groove 22. Linkage rod 42 includes a second end 423, left to and connected to first end 421. A sealing pad 424, 425 is placed on the right and left side of the outer circumference of second end 423. Sealing pad 424 can be attached to seal the airflow channel between intake chamber 11 and main chamber 12. Sealing pad 425 operates in the same manner to seal the airflow channel between main chamber 12 and expel chamber 14. The leftmost side of linkage rod 42 includes a third end 426. The outer circumference of third end 426 includes a ring groove 427 of smaller size. Ring groove 427 is for engaging moveable valve 43. The center area of moveable valve 43 is a rubber oil seal. The center area can move to left and right. Moveable valve 43 is placed at the conjunction of side cover 2 and fixed seat 16 of main body 1. The center includes an engaging hole 431. In assembly, engaging hole 431 is sheathed on the outer circumference of ring groove 427 of linkage rod 42. Spring 41 is engaged to first end 421 of linkage rod 42 so that linkage rod 42 is suspended inside space 10.

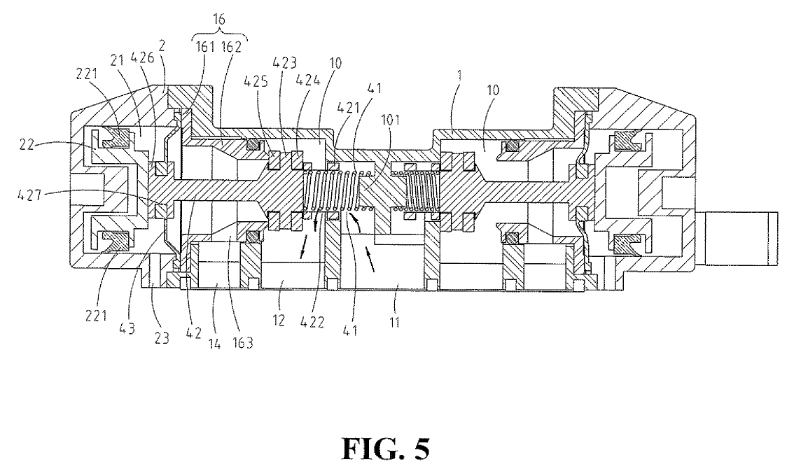

Side cover 2 is engaged on the left side of main body 1. The inside of side cover 2 is an enclosed space 21. Space 21 accommodates a moveable piston 22. The outer circumference of piston 22 includes an oil seal 221. Oil seal 221 is to maintain the seal-tightness of the left side of space 21. When moving to left and to right, piston 22 pushes third end 426 of linkage rod 42 to provide the driving force for the movement of linkage unit 4. As shown in FIG. 5, side cover 2 includes an expel outlet 23 located close to the right edge so that the air in the side of space 21 will be expelled when piston 22 moves.

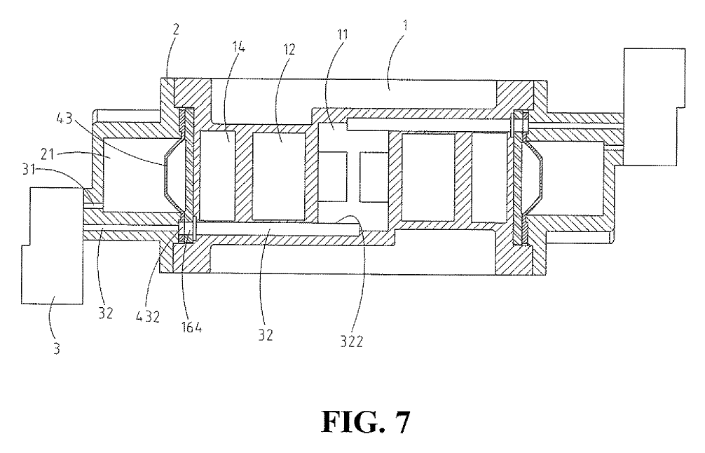

As shown in FIGS. 4 & 7, electromagnetic valve 3 is engaged to the side of side cover 2. Electromagnetic valve 3 is a switch for airflow channel. In FIG. 7, the electromagnetic valve is depicted as a block. Electromagnetic valve 3 is for connecting or blocking a piston channel 31 and an intake channel 32. An outlet 321 on side cover 2 is the outlet of intake channel 32, and an inlet 311 is the inlet of piston channel 31. The internal structure of electromagnetic valve 3 can enable the communication or blockage between piston channel 31 and intake channel 32. In take channel 32 is formed on the shell wall of main body 1 and side cover 2. Fixed seat 16 and moveable valve 43 further includes holes 164, 432 at appropriate location so that the air can flow through intake channel 32. Inlet 322 of intake channel 32 is connected to intake chamber 11, as shown in FIG. 3. Piston channel 31 is located on side cover 2, and is directly connected to space 21 inside side cover 2. When electromagnetic valve 3 moves, piston channel 31 is connected to intake channel 32 so that the air inside intake chamber 11 flows through intake channel 32 and piston channel 32 into space 21 to push piston 22 inside space 21 to the right. FIG. 7 does not show the piston.

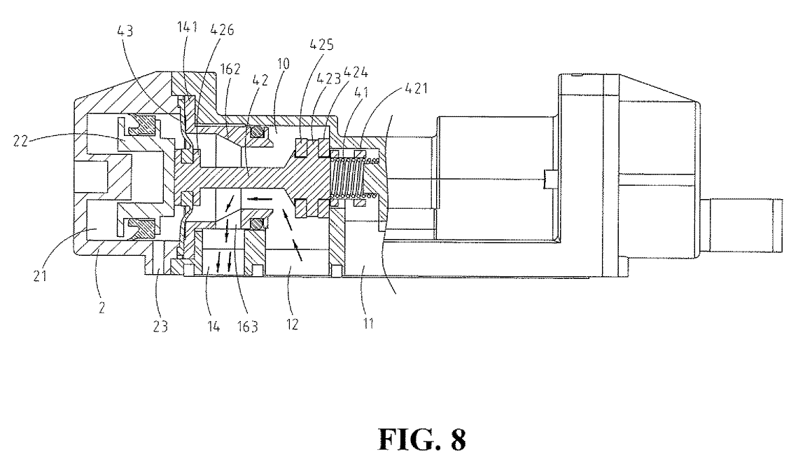

The following describes the entire operation of the present invention. The air control valve of the present invention is placed inside an oxygen concentrator. The compressor continuously compresses the outside air into intake chamber 11 of main body 1. As shown in FIG. 5, as main body 1 is symmetrical for left and right, intake chamber 11 is connected to space 10 from the left and right side. By the timing difference of the internal structure, the air only enters intake chamber 11 either the left side or the right side. As shown in FIG. 5, the left side is used for explanation. In the normal state, linkage unit 4 uses spring 41 to push sealing pad 425 against protruding 162 of fixed seat 16 to seal expel chamber 14. At this time, the air enters main body 1 through intake chamber 11, and then flows through penetrating groove 422 of first end 421 of linkage rod 42 to enter main chamber 12. Finally, the air flows through the outlet of main chamber 12 and other air channels to enter the molecular sieves of the oxygen concentrator for subsequent oxygen concentration process. When the nitrogen concentration in the molecular sieve is too high and ready for expulsion, the nitrogen enters main chamber 12, flows through the outlet of expel chamber 14 and other channels, and is expelled to the outside. As shown in FIG. 7, when electromagnetic valve 3 moves to make intake channel 32 and piston channel 31 connected, the air inside intake chamber 11 flows through intake channel 32 and piston channel 31 into space 21 of side cover 2. As shown in FIG. 8, the air pushes piston 22 to the right so that sealing pad 424 of second end 423 of linkage rod 42 of linkage unit 4 blocks the connection between intake chamber 11 and main chamber 12. Therefore, main chamber 12 is connected to expel chamber 14 through the inside of fixed seat 16 and open groove 163. Hence, the airflow direction is changed, and the nitrogen is expelled from expel chamber 14.

In summary, the air control valve of the present invention uses linkage unit 4 to move back and forth so that sealing pads 424, 425 can be pushed to seal the airflow channels among the chambers to accomplish switching the airflow direction. Also the sealing pads are pushed against the inlet and outlets so as to reduce the abrasion. The result is a better tightness and longer life expectancy of the product. Except the electromagnetic valve needing wire connection for operation control, the other components of the present invention are all placed inside main body 1 without exposed wire. Therefore, the installation is simple for safe use.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A structure of air control valve for oxygen concentrator, comprising:
a main body, having an inside hollow space, said space of said main body further divided by a plurality of separating plates into a plurality of chambers connecting to the outside, said chambers including an intake chamber, at least a main chamber and at least an expel chamber;
at least a linkage unit, located inside said space of said main body, further comprising a spring, a linkage rod and a moveable valve, said left end of said spring being placed at the conjunction of said space and said intake chamber, said moveable valve being placed at the end surface of said main body, the center area of said moveable valve able to move to left and right, the two ends of said linkage rod connected respectively to said spring and said moveable valve, said linkage rod being suspended inside said space of said main body, the outer circumference of said linkage rod having two sealing pads for allowing said main chamber being connected to only either said intake chamber or said expel chamber at any given time;
at least a side cover, engaged to the side of said main body, inside of said side cover forming an enclosed space to accommodate a moveable piston, said piston able to push or pull said linkage unit when moving; and
at least an electromagnetic valve, engaged to the end surface of said side cover, for controlling the connection or blockage of piston channel and intake channel, said intake channel located inside the shell wall of said side cover, said intake channel being connected to said intake chamber, said piston channel being connected to said enclosed space of said side cover.

2. The structure as claimed in claim 1, wherein said space of said main body having a fixed seat at the location near said intake chamber, said fixed seat is an engraved skeleton, and has a hollow plate and a protruding end, said plate is placed near the conjunction of said main body and said side cover, and said protruding end has open grooves on the circumference.

3. The structure as claimed in claim 1, wherein said linkage rod is a long rod with a first end on the right, said first end being hollow to accommodate said left end of said spring, said first end having penetrating groove on the outer circumference, a second end left to and connected to said first end, said second end having a sealing pad on the left and right of the outer circumference respectively, and a third end on the leftmost of said linkage rod, said third end having a ring groove of smaller size on the outer circumference.

4. The structure as claimed in claim 3, wherein the center area of said moveable valve is a rubber oil seal, said center area can move to left and right, said moveable valve has engaging hole in the center to be sheathed on the outer circumference of said linkage rod.

5. The structure as claimed in claim 1, wherein said side cover has an expel outlet inside said enclosed space near the edge conjunction to said main body.

6. The structure as claimed in claim 1, wherein said intake channel is formed inside the shell wall of said main body and said side cover, and said fixed seat and said moveable valve have holes on appropriate location to allow airflow.

7. The structure as claimed in claim 1, wherein said linkage unit uses said sealing pads on said linkage rod to seal said airflow channel between said chambers by pressing said sealing pads against said chambers.
